(19) United States
(12) Patent Application Publication
(10) Pub. No.: US 2023/0351915 A1
(43) Pub. Date: Nov. 2, 2023

(54) ONLINE PHYSICAL BODY POSE SYNCHRONIZATION

(71) Applicant: Avaya Management L.P., Durham, NC (US)

(72) Inventors: Sandesh Chopdekar, Kondhwa (IN); Pushkar Deole, Karvenagar (IN)

(21) Appl. No.: 17/733,722

(22) Filed: Apr. 29, 2022

(51) Int. Cl. G09B 19/00; G06V 40/20; G06V 10/74

(52) U.S. Cl. CPC G09B 19/003; G06V 40/20; G06V 10/761; H04L 65/403

(57) ABSTRACT

The systems and methods of the present disclosure provide for synchronizing movements of participants during a communication session. The method includes receiving, by a processor, captured image data of movement of a first participant to a communication session and receiving, by the processor, captured image data of movement of a second participant to the communication session, The method also includes determining, by the processor, if a variance exists in the movement of the second participant to that of the movement of the first participant; and if a variance exists in the movement of the second participant to that of the movement of the first participant, signaling, by the processor, the second participant to adjust the movement of the second participant to match the movement of the first participant.

### FIELD

The present disclosure relates generally to systems and methods for multi-participant communication conferencing and particularly relates to systems and methods for synchronizing movements of participants during multi-participant communication conferencing.

### BACKGROUND

One of the major challenges in conducting online or in person physical training sessions is the difficulty experienced by a participant trying to follow the instructions or movements of the trainer using proper form. During the training session, the participant generally focuses on his or her own posture or position in order to mimic the movements performed by the trainer, while not necessarily observing the trainer at all times. For example, to mimic the movements (e.g., a certain posture, pose or position) performed by the trainer, the participant may need to turn away from a monitor or screen in which the trainer is displayed in order to mimic these movements. Therefore, it is difficult for the participant to know whether the mimicked movements have been performed correctly or not. Even while observing the trainer on the monitor or screen, the participant is not confident that the mimicked movements have been performed correctly since there is no one to oversee the participant.

During the training session. there will be times where the participant will not be observing the trainer (e.g., when the participant is positioning his or her body to mimic a movement) and there are times when the trainer is also not able to observe one or more of the participants (e.g., when the trainer is facing away from the camera). Even when a participant feels confident that he or she is performing the movement correctly, more than likely, the movements mimicked by the participant are not the same as the movements actually performed by the trainer. Simultaneously focusing on observing the movements performed by the trainer and mimicking the movements performed by the trainer using correct form is a difficult task to accomplish especially for beginners to an exercise program.

In fact, not being able to properly follow a trainer's instructions could lead to injuries due to performing incorrect movements. For example, while performing yoga, a participant needs to hold a pose for a long period of time. If the pose is performed incorrectly, holding the incorrect pose could be damaging for the participant. Even if a participant checks all of the steps of a particular exercise routine, it requires lots of practice for the participant to master the steps while following the trainer. This applies not only to exercise routines, but also applies to other forms of physical activity such as dancing or even acting. Viewing online videos to mimic movements performed by a presenter is extra challenging since there is no one present to observe the viewer performing the movements for correctness.

Conventionally, one technique to solve this problem is to require a person (e.g., a trainer) to be in the presence of the participant mimicking the movements to ensure that the movements are performed correctly. This technique is of course costly. Another technique is to have a remotely located trainer perform the movements for multiple participants. The remotely located trainer has a limited ability to observe each of the participants perform the movements. For example, if a participant is out of view or not facing the camera, it is difficult for the remotely located trainer to actually determine whether or not a participant is performing the movements correctly. Moreover, one participant watching the trainer and another participant simultaneously is also difficult. A further technique involves having both the remotely located trainer and the participant perform the movements in front of a mirror. The participant, however, would be unsure that the movements are performed correctly when not looking into the mirror. A further technique involves having a participant record the performed movements and then critique the recording to determine if the movements were performed correctly. This technique, however, suffers from the drawback of being cumbersome, difficult and time consuming to perform.

Therefore, there is a need for systems and methods for synchronizing the movements of participants during multi-participant communication conferencing.

### SUMMARY

These and other needs are addressed by the various embodiments and configuration of the present disclosure. The present disclosure can provide a number of advantages depending on the particular configuration. These and other advantages will be apparent from the disclosure contained therein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “conference” as used herein refers to any communication or set of communications, whether including audio, video, text, or other multimedia data, between two or more communication endpoints and/or users. Typically, a conference includes two or more communication endpoints. The terms “conference” and “conference call” are used interchangeably throughout the specification.

The term “communication device” or “communication endpoint” as used herein refers to any hardware device and/or software operable to engage in a communication session. For example, a communication device can be an Internet Protocol (IP)-enabled phone, a desktop phone, a cellular phone, a personal digital assistant, a soft-client telephone program executing on a computer system, etc. IP-capable hard- or softphone can be modified to perform the operations according to embodiments of the present disclosure.

The term “network” as used herein refers to a system used by one or more users to communicate. The network can consist of one or more session managers, feature servers, communication endpoints, etc. that allow communications, whether voice or data, between two users. A network can be any network or communication system as described in conjunction with FIG. 1. Generally, a network can be a LAN, wide area network (WAN), a wireless LAN, a wireless WAN, the Internet, etc. that receives and transmits messages or data between devices. A network may communicate in any format or protocol known in the art, such as, transmission control protocol/internet protocol (TCP/IP), 802.11g, 802.11n, Bluetooth, or other formats or protocols.

The term “communication event” and its inflected forms includes: (i) a voice communication event, including but not limited to a voice telephone call or session, the event being in a voice media format, or (ii) a visual communication event, the event being in a video media format or an image-based media format, or (iii) a textual communication event, including but not limited to instant messaging, internet relay chat, e-mail, short-message-service, Usenet-like postings, etc., the event being in a text media format, or (iv) any combination of (i), (ii), and (iii).

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection of individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium” as used herein refers to any tangible storage and/or transmission medium that participate in providing instructions to a processor for execution. The computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, etc. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multi-value, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases. “Database management systems” (DBMSs) are specially designed applications that interact with the user, other applications, and the database itself to capture and analyze data.

The terms “determine”, “calculate” and “compute,” and variations thereof, are used interchangeably and include any type of methodology, process, mathematical operation or technique.

The term “electronic address” refers to any contactable address, including a telephone number, instant message handle, e-mail address, Universal Resource Locator (URL), Universal Resource Identifier (URI), Address of Record (AOR), electronic alias in a database, like addresses, and combinations thereof.

An “enterprise” refers to a business and/or governmental organization, such as a corporation, partnership, joint venture, agency, military branch, and the like.

A “geographic information system” (GIS) is a system to capture, store, manipulate, analyze, manage, and present all types of geographical data. A GIS can be thought of as a system—it digitally makes and “manipulates” spatial areas that may be jurisdictional, purpose, or application-oriented. In a general sense, GIS describes any information system that integrates, stores, edits, analyzes, shares, and displays geographic information for informing decision making.

The terms “instant message” and “instant messaging” refer to a form of real-time text communication between two or more people, typically based on typed text. Instant messaging can be a communication event.

The term “internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™ store every word of every page they find.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of Internet Protocol (IP) networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The term “social network” refers to a web-based social network maintained by a social network service. A social network is an online community of people, who share interests and/or activities or who are interested in exploring the interests and activities of others.

The term “sound” or “sounds” as used herein refers to vibrations (changes in pressure) that travel through a gas, liquid, or solid at various frequencies. Sound(s) can be measured as differences in pressure over time and include frequencies that are audible and inaudible to humans and other animals. Sound(s) may also be referred to as frequencies herein.

The terms “audio output level” and “volume’ are used interchangeably a refer to the amplitude of sound produced when applied to a sound producing device.

The term “multi-party” as used herein may refer to communications involving at least two parties. Examples of multi-party calls may include, but are in no way limited to, person-to-person calls, telephone calls, conference calls, communications between multiple participants, and the like.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell Intel® Core® i5-3570K 22 nm Ivy Bridge, the AMD® FX™ family of processors, AMD® 4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJ-S™ processors, other industry-equivalent processors, and may perform computational functions using any known or future-developed standard, instruction set, libraries, and/or architecture.

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a sub element identifier when a sub element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The present disclosure will be described in conjunction with the appended figures.

FIG. 1 is a block diagram of an illustrative communication system used for synchronizing movements of participants during multi-participant communication conferencing according to embodiments of the present disclosure.

FIG. 2 is a block diagram of an illustrative communication system highlighting the features of a conferencing server used for synchronizing movements of participants during multi-participant communication conferencing according to embodiments of the present disclosure.

FIG. 3 is a block diagram of an illustrative communication system used for synchronizing movements of participants during multi-participant communication conferencing according to embodiments of the present disclosure.

FIG. 4 is a flow diagram of a method used for synchronizing movements of participants during multi-participant communication conferencing according to embodiments of the present disclosure.

FIGS. 5A and 5B are block diagrams illustrating body parts that can be detected using the sync pose feature according to embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. Various changes may be made in the function and arrangement of elements without departing from the spirit and scope of the disclosure.

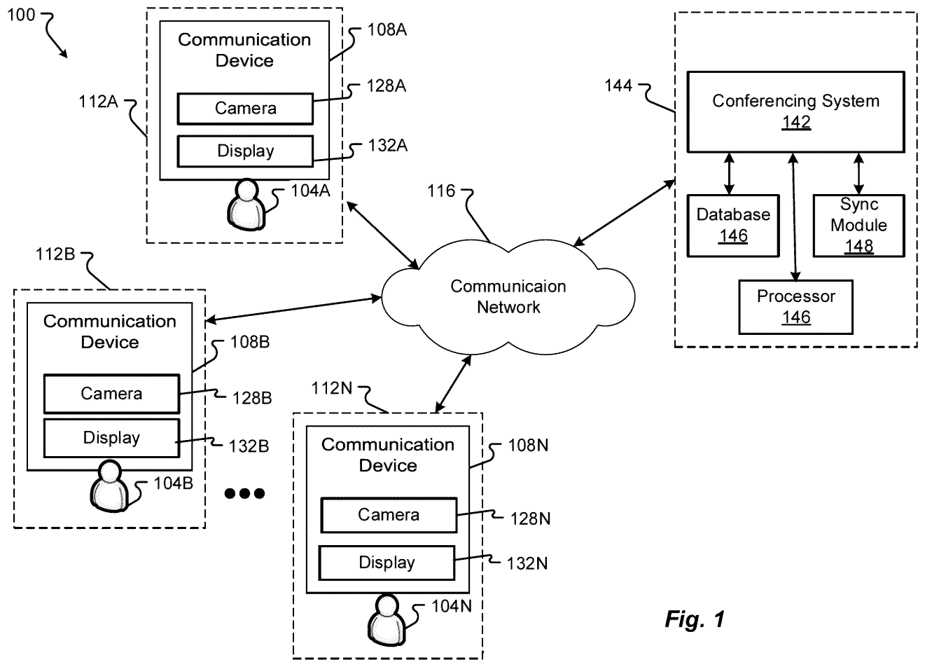

FIG. 1 is a block diagram of an illustrative communication system 100 used for synchronizing movements of participants during multi-participant communication conferencing according to embodiments of the present disclosure. Referring to FIG. 1, the communication system 100 is illustrated in accordance with at least one embodiment of the present disclosure. The communication system 100 may allow a user 104A to participate in the communication system 100 using a communication device 108A having a camera 128A and a display 132A. As used herein, communication devices include user devices. Other users 104B to 104N also can participate in the communication system 100 using respective communication devices 108B through 108N having cameras 128B to 128N and displays 132B to 132N. In accordance with embodiments of the present disclosure, one or more of the users 104A-104N may access a conferencing system 142 utilizing the communication network 116.

The cameras 128A-128N may correspond to an electronic device capable of capturing and/or processing an image and/or a video content. The cameras 128A-128N may include suitable logic, circuitry, interfaces, and/or code that may be operable to capture and/or process an image and/or a video content. In an embodiment, the cameras 128A-128N may be a pan-tilt-zoom (PTZ) camera. In an embodiment of the present disclosure, the pan, tilt, and/or zoom of the cameras 128A-128N may be controlled mechanically. In another embodiment, the pan, tilt, and/or zoom of the cameras 128A-128N may be electronically controlled using solid state components.

In an embodiment of the present disclosure, the cameras 128A-128N may be high resolution cameras that capture high-resolution wide-angle images and/or videos. In another embodiment of the present disclosure, the cameras 128A-128N may be built from a plurality of smaller-resolution cameras. The plurality of smaller resolution cameras may be built into a single housing. In another embodiment, the plurality of smaller resolution cameras may be separate. In such a case, output signals of the plurality of smaller resolution cameras may be calibrated. Images and/or videos captured by the plurality of smaller resolution cameras may be combined into a single high-resolution image. In an embodiment of the present disclosure, the plurality of smaller resolution cameras may be set up such that the field of view of the plurality of smaller resolution cameras may overlap so that their combined output signal results in a high-resolution image.

In an embodiment of the present disclosure, the cameras 128A-128N may be installed at one or more locations in the vicinity of a participant to be tracked. The cameras 128A-128N may be installed at locations such that the cameras 128A-128N may be able to automatically capture images of the tracked participants. In an embodiment of the present disclosure, the cameras 128A-128N may be installed in such a way that a position of each of the cameras 128A-128N is fixed. In an alternative embodiment, one or more of the cameras 128A-128N, may be installed in such a way that one or more of the cameras may be controlled electronically and/or mechanically. The cameras 128A-128N may be operable to adjust the pan, tilt, and/or zoom based on one or more signals received from a control device. The cameras 128A-128N may be operable to transmit one or more signals to the control device.

In some embodiments of the present disclosure, each of the communication devices 108A-108N may include audio input/output devices (not shown) that may be separate from the communication devices 108A-108N. For example, an audio input device may include, but is not limited to, an audio detection microphone that is separate from a receiver microphone used by the communication devices 108A-108N to convey audio to one or more of other communication devices 108A-108N and a conferencing system 142. Additionally, or alternatively, the audio input device may be a part of, or built into, the communication devices 108A-108N. In some embodiments, the audio output device may include, but is not limited to speakers, which are part of a headset, standalone speakers or speakers integrated into the communication devices 108A-108N.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the TCP/IP suite of protocols. Communications supported by the communication network 116 include real-time, near-real-time, and non-real-time communications. For instance, the communication network 116 may support voice, video, text, web-conferencing, or any combination of media. Moreover, the communication network 116 may include a number of different communication media such as coaxial cable, copper cable/wire, fiber-optic cable, antennas for transmitting/receiving wireless messages, and combinations thereof. In addition, it can be appreciated that the communication network 116 need not be limited to any one network type, and instead may include a number of different networks and/or network types. It should be appreciated that the communication network 116 may be distributed. Although embodiments of the present disclosure will refer to one communication network 116, it should be appreciated that the embodiments claimed herein are not so limited. For instance, more than one communication network 116 may be joined by combinations of servers and networks.

The term “communication device” as used herein is not limiting and may be referred to as a user device and mobile device, and variations thereof. A communication device, as used herein, may include any type of device capable of communicating with one or more other device and/or across a communications network, via a communications protocol, and the like. A communication device may comprise any type of known communication equipment or collection of communication equipment. Examples of an illustrative communication device may include, but are not limited to, any device with a sound and/or pressure receiver, a cellular phone, a smart phone, a telephone, handheld computers, laptops, netbooks, notebook computers, subnotebooks, tablet computers, scanners, portable gaming devices, pagers, GPS modules, portable music players, smart watch, and other sound and/or pressure receiving devices. A communication device does not have to be Internet-enabled and/or network-connected. In general, each communication device may provide many capabilities to one or more users who desire to use or interact with the conferencing system 142. For example, a user may access the conferencing system 142 utilizing the communication network 116.

Capabilities enabling the disclosed systems and methods may be provided by one or more communication devices through hardware or software installed on the communication device, such as an application. For example, the application may be in the form of a communication application and can be used for synchronizing movements of participants during multi-participant communication conferencing. This application may be in the form of a synchronization (“sync”) pose feature provided on each of the communication devices 108A-108N. The sync pose feature can be activated during the conference call, for example, and when selected, this feature ensures that the movements of the participants are in sync with the movements of the trainer during a fitness routine, such as but not limited to an exercise routine, fitness training, weight training, yoga, Pilates, instructional performances such as dancing, acting, etc. The sync pose feature prompts the participant to perform movements in sync with movements performed by the trainer.

In general, each communication device 108A-108N may provide many capabilities to one or more users 104A-104N who desire to interact with the conferencing system 142. Although each communication device 108A-108N is depicted as being utilized by one user, one skilled in the art will appreciate that multiple users may share any single communication device 108A-108N.

In some embodiments, the conferencing system 142 may reside within a server 144. The server 144 may be a server that is administered by an enterprise associated with the administration of communication device(s) or owning communication device(s), or the server 144 may be an external server that can be administered by a third-party service, meaning that the entity which administers the external server is not the same entity that either owns or administers a communication device. In some embodiments of the present disclosure, an external server may be administered by the same enterprise that owns or administers a communication device. As one particular example, a communication device may be provided in an enterprise network and an external server may also be provided in the same enterprise network. As a possible implementation of this scenario, the external server may be configured as an adjunct to an enterprise firewall system, which may be contained in a gateway or Session Border Controller (SBC) which connects the enterprise network to a larger unsecured and untrusted communication network. An example of a messaging server is a unified messaging server that consolidates and manages multiple types, forms, or modalities of messages, such as voice mail, email, short-message-service text message, instant message, video call, and the like. As another example, a conferencing server is a server that connects multiple participants to a conference call. As illustrated in FIG. 1, server 144 includes a conferencing system 142, a processor 145, sync module 148 and database 146.

Although various modules and data structures for the disclosed systems and methods are depicted as residing on the server 144, one skilled in the art can appreciate that one, some, or all of the depicted components of the server 144 may be provided by other software or hardware components. For example, one, some, or all of the depicted components of the server 144 may be provided by logic on a communication device (e.g., the communication device may include logic for the systems and methods disclosed herein so that the systems and methods are performed locally at the communication device). Further, the logic of an application (not shown) can be provided on the server 144 (e.g., the server 144 may include logic for the systems and methods disclosed herein so that the systems and methods are performed at the server 144). In embodiments of the present disclosure, the server 144 can perform the methods disclosed herein without use of logic on any communication devices 108A-108N.

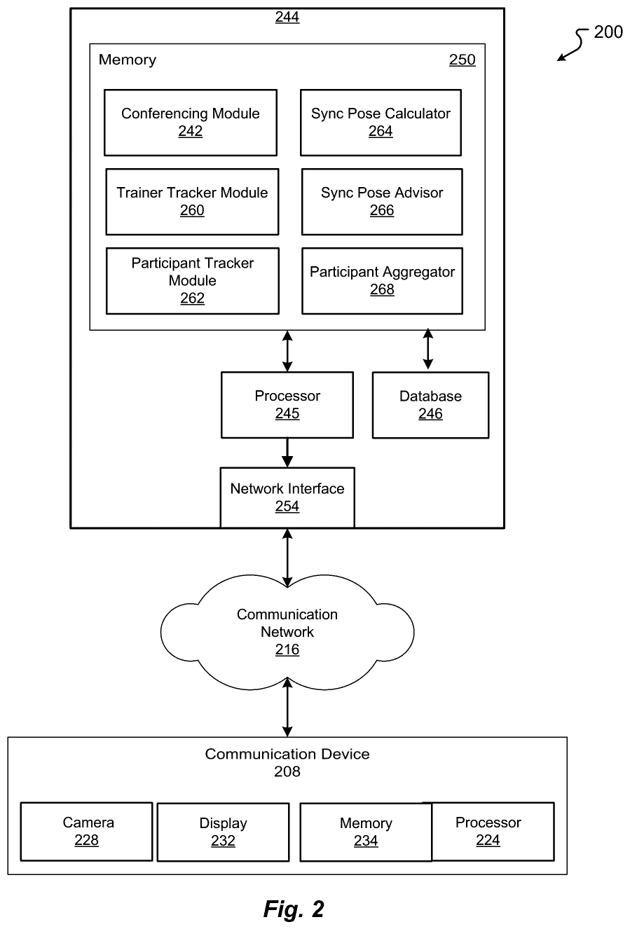

The conferencing system 142 implements functionality for the systems and methods described herein by interacting with two or more of the communication devices 108A-108N, applications, features of the features of the sync module 148 (discussed in greater detail in FIG. 2) and database 146, and/or other sources of information as discussed in greater detail below that can allow two or more communication devices 108 to participate in a multi-party call. One example of a multi-party call includes, but is not limited to, a person-to-person call, a conference call between two or more users/parties, and the like. Although some embodiments of the present disclosure are discussed in connection with multi-party calls, embodiments of the present disclosure are not so limited. Specifically, the embodiments disclosed herein may be applied to one or more video, multimedia, conference calls, web conferences, and the like.

In some embodiments of the present disclosure, the conferencing system 142 can include one or more resources such as conferencing infrastructure (not shown). As can be appreciated, the resources of the conferencing system 142 may depend on the type of multi-party call provided by the conferencing system 142. Among other things, the conferencing system 142 may be configured to provide conferencing of at least one media type between any number of participants. The conferencing infrastructure can include hardware and/or software resources of the conferencing system 142 that provide the ability to hold multi-party calls, conference calls, and/or other collaborative communications.

The database 146 may include information pertaining to one or more of the users 104A-104N, communication devices 108A-108N, and conferencing system 142, among other information. For example, the database 146 can include settings for personalized information, communication devices, users, and applications.

FIG. 2 is a block diagram of an illustrative communication system 200 highlighting the features of a conferencing server 244 used for synchronizing movements of participants during multi-participant communication conferencing according to embodiments of the present disclosure. The communication system 200 may allow users such as users 104A and 104B to participate in a conference call. During the conference call, either user 104A or 104B is designated as the trainer and the other of user 104A or 104B is designated as the participant. According to one embodiment of the present disclosure, more than two users can join the conference call, but one of the users has to be designated as the trainer and the remainder of the users are designated as participants. Components shown in FIG. 2 may correspond to those shown and described in FIG. 1

The conferencing server 244 implements functionality establishing the conference call for the systems and methods described herein by interacting with the communication devices (including its hardware and software components) and the various components of the conferencing server 244. For example, the conferencing server 244 includes a memory 250, a database 246 and a processor 245. Furthermore, the conferencing server 244 includes a network interface 254. The memory 250 may include an application (not shown) (used in conjunction with applications (not shown) of the communication devices 108A-108N), a conferencing module 242 (similar to the conferencing system 142 illustrated in FIG. 1), a trainer tracker module 260, a participant tracker module 262, a sync pose calculator 264, a sync pose advisor 266 and a participant aggregator 268. The trainer tracker module 260, the participant tracker module 262, the sync pose calculator 264, the sync pose advisor 266 and the participant aggregator 268 are part of the sync module 148 illustrated in FIG. 1. Although the trainer tracker module 260, the participant tracker module 262, the sync pose calculator 264, the sync pose advisor 266 and the participant aggregator 268 which are part of the sync module 148, are illustrated as being part of the conferencing server 244, these features do not necessarily have to be part of the conferencing server 244 and may not be tightly coupled with the conferencing server 244. According to one embodiment of the present disclosure, these sync pose features can be loosely coupled with the conferencing server 244 and hence, these sync pose features may be plugged into any video calling application without departing from the spirit and scope of the present disclosure.

The processor 245 may include a microprocessor, Central Processing Unit (CPU), a collection of processing units capable of performing serial or parallel data processing functions, and the like. The memory 250 may include a number of applications or executable instructions that are readable and executable by the processor 245. For example, the memory 250 may include instructions in the form of one or more modules and/or applications. The memory 250 may also include data and rules in the form of threshold setting that can be used by one or more of the modules and/or applications described herein. The memory 250 may also include one or more communication applications and/or modules, which provide communication functionality of the conferencing sever 244. In particular, the communication application(s) and/or module(s) may contain the functionality necessary to enable the conferencing server 244 to communicate with communication device 208 as well as other communication devices (not shown) across the communication network 216. As such, the communication application(s) and/or module(s) may have the ability to access communication preferences and other settings, maintained within database 246 and/or memory 250), format communication packets for transmission via the network interface 254, as well as condition communication packets received at network interface 254 for further processing by the processor 245.

Among other things, the memory 250 may be used to store instructions, that when executed by the processor 245 of the communication system 200, perform the methods as provided herein. In some embodiments of the present disclosure, one or more of the components of the communication system 200 may include a memory 250. In one example, each component in the communication system 200 may have its own memory 250. Continuing this example, the memory 250 may be a part of each component in the communication system 200. In some embodiments of the present disclosure, the memory 250 may be located across the communication network 216 for access by one or more components in the communication system 200. In any event, the memory 250 may be used in connection with the execution of application programming or instructions by the processor 245, and for the temporary or long-term storage of program instructions and/or data. As examples, the memory 250 may comprise RAM, DRAM, SDRAM, or other solid-state memory. Alternatively, or in addition, the memory 250 may be used as data storage and can comprise a solid-state memory device or devices. Additionally, or alternatively, the memory 250 used for data storage may include a hard disk drive or other random-access memory. In some embodiments of the present disclosure, the memory 250 may store information associated with a user, a timer, rules, recorded audio information, notification information, and the like. For instance, the memory 250 may be used to store predetermined speech characteristics, private conversation characteristics, information related to mute activation/deactivation, times associated therewith, combinations thereof, and the like.

The network interface 254 includes components for connecting the conferencing server 244 to communication network 216. In some embodiments of the present disclosure, a single network interface 254 connects the conferencing server 244 to multiple networks. In some embodiments of the present disclosure, a single network interface 254 connects the conferencing server 244 to one network and an alternative network interface is provided to connect the conferencing server 244 to another network. The network interface 254 may include a communication modem, a communication port, or any other type of device adapted to condition packets for transmission across a communication network 216 to one or more destination communication devices (not shown), as well as condition received packets for processing by the processor 245. Examples of network interfaces include, without limitation, a network interface card, a wireless transceiver, a modem, a wired telephony port, a serial or parallel data port, a radio frequency broadcast transceiver, a USB port, or other wired or wireless communication network interfaces.

The type of network interface 254 utilized may vary according to the type of network which the conferencing server 244 is connected, if at all. Exemplary communication networks 216 to which the conferencing server 244 may connect via the network interface 264 include any type and any number of communication mediums and devices which are capable of supporting communication events (also referred to as “phone calls,” “messages,” “communications” and “communication sessions” herein), such as voice calls, video calls, chats, emails, TTY calls, multimedia sessions, or the like. In situations where the communication network 216 is composed of multiple networks, each of the multiple networks may be provided and maintained by different network service providers. Alternatively, two or more of the multiple networks in the communication network 216 may be provided and maintained by a common network service provider or a common enterprise in the case of a distributed enterprise network.

A conference mixer (not shown) as well as other conferencing infrastructure can include hardware and/or software resources of the conferencing system that provide the ability to hold multi-party calls, conference calls, and/or other collaborative communications. As can be appreciated, the resources of the conferencing system may depend on the type of multi-party call provided by the conferencing system. Among other things, the conferencing system may be configured to provide conferencing of at least one media type between any number of participants. The conference mixer may be assigned to a particular multi-party call for a predetermined amount of time. In one embodiment of the present disclosure, the conference mixer may be configured to negotiate codecs with each communication device 208 participating in a multi-party call. Additionally, or alternatively, the conference mixer may be configured to receive inputs (at least including audio inputs) from each participating communication device 208 and mix the received inputs into a combined signal which can be provided to each communication device 208 in the multi-party call.

The sync pose feature prompts the participant to position movements in sync with movements performed by the trainer. The sync pose feature operates by first tracking/monitoring and identifying movements and/or poses of one of the participants (e.g., the trainer) in real-time. The sync pose feature then tracks/monitors and identifies the movements and/or poses of the participant(s) in real-time. According to the operation of the sync pose feature, if the movements or poses of the participant(s) are not in sync with the movements or poses of the trainer, the sync pose feature prompts the participant(s) the difference(s) in the movements or poses. The prompt indicates to the participant(s) which body part of the participant(s) to move, the direction in which to move the body part and to what degree to move the body part of the participant. For example, if a trainer's right hand is held straight up in the air, while the right hand of one of the participants is slightly bent, the sync pose feature prompts the participant to straighten out his or her right hand. As another example, if a trainer's head is turned and completely facing the right-hand side of a room, while the participant's head is not completely facing the right-hand side of the room, the sync pose feature prompts the participant to turn his or her head more towards the right-hand side of the room. Therefore, according to embodiments of the present disclosure, the movements and poses of both the trainer and the participants are tracked and the variance of each of the participants with that of the trainer is calculated. If there is a variance, the participant will be prompted to correct his or her pose or movement to align with the pose or the movement of the trainer.

According to embodiments of the present disclosure, libraries such as “OpenPose” or “Densepose” can be used to identify and track the movements of the trainer and participant(s). As discussed in greater detail below, these libraries can be stored either on the conferencing server 244 or the communication device(s) 208. Modern depth camera such as camera 228 are well equipped for estimating 3D models of images and videos. 3D human pose estimation is used to predict the location of body joints in 3D space. 3D human pose estimation can be performed on monocular images or videos using normal camera feeds.

The trainer tracker module 260 can be any hardware/software that can manage an image or video stream, such as a video server, a video switch, an image processor, a Digital Signaling Processor (DSP), and/or the like. The image or video stream is captured in real-time. The trainer tracker module 260 is shown as part of the conferencing server 244, however, in some embodiments of the present disclosure, the trainer tracker module 260 may operate external to the conferencing server 244 and may operate in the communication device 208 of the trainer. When not operating in the communication device 208 of the trainer, the trainer tracker module 260 communicates with the camera 228 of the communication device 208 of the trainer. According to one embodiment of the present disclosure, image or video data for the trainer tracker module 260 may be pre-recorded. For pre-recorded video pose/movement information can be stored along with the video. For example, subtitles and timestamps can be saved for the video.

The participant tracker module 262 can be any hardware/software that can manage an image or video stream, such as a video server, a video switch, an image processor, a Digital Signaling Processor (DSP), and/or the like. The image or video stream is captured in real-time. The participant tracker module 262 is shown as part of the conferencing server 244, however, in some embodiments of the present disclosure, the participant tracker module 262 may operate external to the conferencing server 244 and may operate in the communication device 208 of the participant. When not operating in the communication device 208 of the participant, the participant tracker module 262 communicates with the camera 228 of the communication device 208 of the participant.

The sync pose calculator 264 can be any hardware/software that can process an image, a video stream, and/or an audio stream for variances. According to embodiments of the present disclosure, the sync pose calculator 264 receives the image/video data from the trainer tracker module 260 and the participant tracker module 262. The sync pose calculator 264 calculates the difference in the pose and movement between the trainer and the participant. The sync pose calculator 264 also determines the variance of the participant from the trainer, and informs the sync pose advisor 266 of the pose/movement that the participant needs to make to match the pose/movement of the trainer. When calculating the difference between the participant and the trainer, the sync pose calculator 264 takes into consideration several factors regarding the participant, including, but not limited to the health and medical history of the participant, vital statistics such as the age, height and weight of the participant, the training attendance history of the participant, the medical conditions such as the heart rate, blood pressure, and the like. This information can be uploaded and stored in a user profile in the database 246 from the communication device 208, for example.

According to embodiment of the present disclosure, these factors are considered when calculating the variance and the subsequent advice/correction for the participant. For example, if a participant's heartbeat increases beyond a threshold value during exercising, the sync pose calculator 264 uses this information to adjust the variance for the participant. These factors are considered when performing exercises such a stretching which may be too strenuous for certain participants. According to an embodiment of the present disclosure, artificial intelligence (AI) models and machine learning models such as neural network models may be employed to calculate the variance. As such, the sync pose calculator 264 can be trained to calculate the variance, and then used for performing calculations on real-time data.

The sync pose advisor 266 can be any hardware/software that can advise/prompt the participant that the participant needs to correct his or her pose. The sync pose advisor 266 can communicate with communication device 208 to provide and audio or image signal to prompt the participant to correct his or her pose or movement. According to one embodiment of the present disclosure, the sync pose advisor 266 sends a signal to the communication device 208 to activate the speaker (not shown) or the display 232 to generate a prompt to the participant. The prompt can be in the form of a bar/circle at the left/side of the display 232 of the communication device 208 that changes color according to the variance.

The participant aggregator 268 can be any hardware/software that receives the inputs from the sync pose calculator 264 which includes all of the information for each of the participants. According to embodiments of the present disclosure, the participant aggregator 268 allows the trainer to evaluate each of the participants to determine which participants are varying the most in their poses. According to embodiments of the present disclosure, the participants with the greatest variance can be highlighted in a different color than the rest of the participants using the participant aggregator 268.

The communication system 200 further includes the communication device 208 which may include an application (not shown), a network interface (not shown) a camera 228, a display 232, a memory 234 and a processor 224. Although the details of only one communication device 208 are depicted in FIG. 2, one skilled in the art will appreciate that one or more other communication devices may be equipped with similar or identical components as the communication device 208 depicted in detail.

The processor 224 may include a microprocessor, Central Processing Unit (CPU), a collection of processing units capable of performing serial or parallel data processing functions, and the like. The processor 224 interacts with the memory 234, and network interface and may perform various functions of an application used for synchronizing movements of participants during multi-participant communication conferencing. As stated above, this application may be in the form of a sync pose feature provided to each of the participants.

Although various modules and data structures for disclosed systems and methods are depicted as residing on the conferencing server 244, one skilled in the art can appreciate that one, some, or all of the depicted components of the conferencing server 244 may be provided by other software or hardware components. For example, one, some, or all of the depicted components of the conferencing server 244 may be provided by systems operating on the communication device 208. According to an alternative embodiment of the present disclosure, the communication device 208 may include all the necessary logic for the systems and methods disclosed herein so that the systems and methods are performed at the communication device 308. Thus, the communication device 208 can perform the methods disclosed herein without use of logic on conferencing server 244.

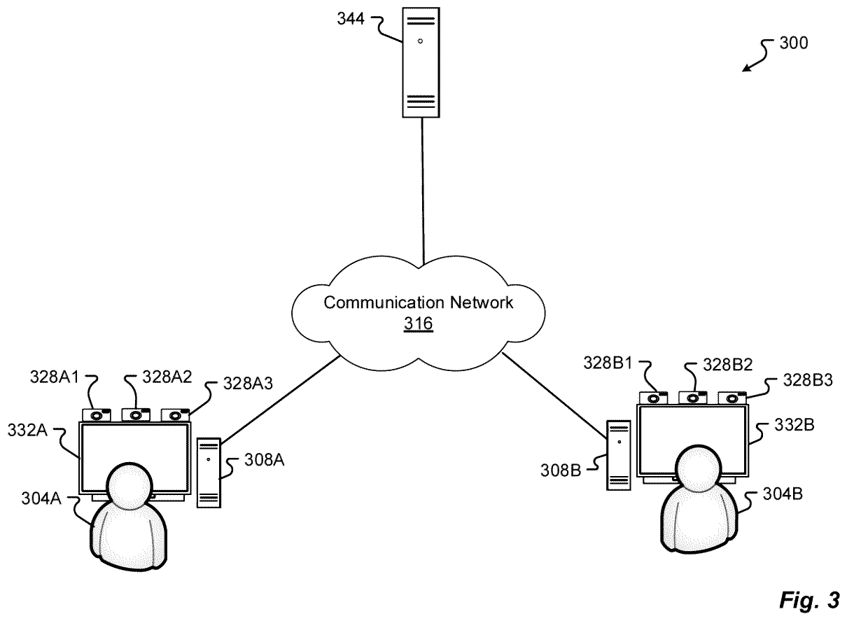

FIG. 3 is a block diagram of an illustrative communication system 300 used for synchronizing movements of participants during multi-participant communication conferencing according to embodiments of the present disclosure. As illustrated in FIG. 3, user-trainer 304A performs movements using computing device 308A along with display 332A and cameras 328A1-328A3. User-participant 304B mimics the movements of user-trainer 304A using computing device 308B along with display 332B and cameras 328B1-328B3. These movements are performed during a conference call using conferencing server 344 and communication network 316. Each of user-trainer 304A and user-participant 304B activates the sync pose feature from the communication devices 308A-308B, during the conference call, to ensure that the movements of the participant are in sync with the movements of the trainer during a fitness routine. Cameras 328A1-328A3 and cameras 328B1-328B3 are installed in multiple different positions to capture images/poses of the user-trainer 304A and user-participant 304B, respectively, from multiple angles such as in two-dimensional (2D) imaging and three-dimensional (3D) imaging. According to one embodiment of the present disclosure, cameras 328A2 and 328B2 may serve as main cameras and cameras 328A1, 328A3, 328B1 and 328B3 may server as tracking cameras. One or more main cameras and one or more tracking camera may be provided at various positions.

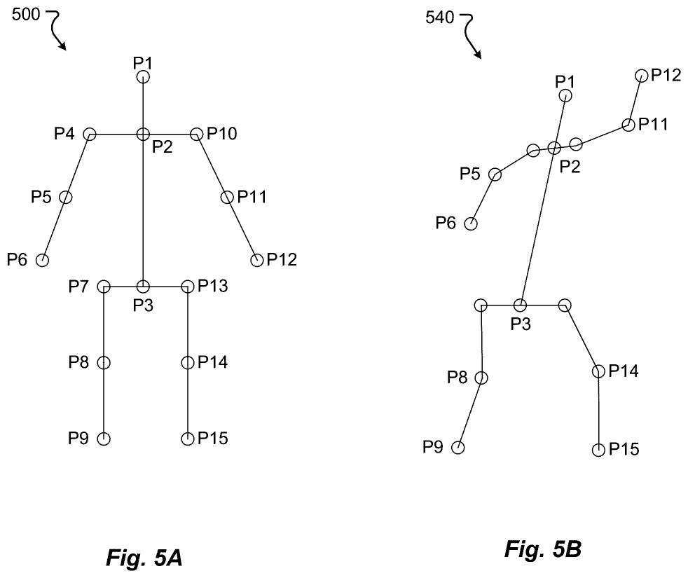

FIGS. 5A and 5B are block diagrams 500, 540 illustrating body parts that can be detected using the sync pose feature according to embodiments of the present disclosure. As illustrated in FIG. 5A, the sync pose feature can detect locations (or positions) and displacement of fifty body parts (or key points) of the human body, including the head P1, the top of the body P2, and the bottom of the body P3 located on the body centerline; the left shoulder P4, the left elbow P5, the left wrist P6, the left hip P7, the left knee P8, and the left ankle P9 located on the left half of the body; the right shoulder P10, the right elbow P11, the right wrist P12, the right hip P13, the right knee P14, and the right ankle P15 located on the right half of the body. In a simple mode, the detecting device 50 can be operable to detect locations and displacement of five body parts of the human body. The five body parts are respectively located on the body centerline (e.g. choosing one of the head P1, the top of the body P2, and the bottom of the body P3), the left hand (e.g. choosing one of the left elbow P5 and the left wrist P6), the left leg (e.g. choosing one the left knee PS and the left ankle P9), the right hand (e.g. choosing one of the right elbow P11 and the right wrist P12), and the right leg (e.g. choosing one of the right knee P14 and the right ankle P15). As shown in FIG. 5B the posture and/or movement of the user can be recognized by tracking the displacement of the aforementioned body parts. The key points in the figures may be connected to form the skeleton.

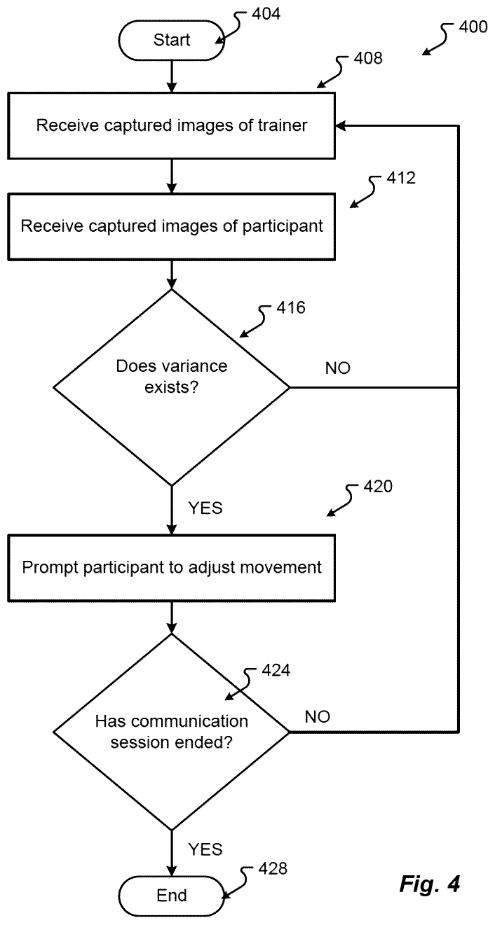

FIG. 4 is a flow diagram of a method 400 used for synchronizing movements of participants during multi-participant communication conferencing according to embodiments of the present disclosure. While a general order of the steps of method 400 is shown in FIG. 4, method 400 can include more or fewer steps or can arrange the order of the steps differently than those shown in FIG. 4. Further, two or more steps may be combined into one step. Generally, method 400 starts with a START operation at step 404 and ends with an END operation at step 428. Method 400 can be executed as a set of computer-executable instructions executed by a data-processing system and encoded or stored on a computer readable medium. Hereinafter, method 400 shall be explained with reference to systems, components, modules, software, data structures, user interfaces, etc. described in conjunction with FIGS. 1-3 and 5A and 5B.

Method 400 starts with the START operation at step 404 and proceeds to step 408, where the processor 245 using the trainer tracker module 260 of the conferencing server 244 receives captured images of the trainer. After receiving captured images of the trainer at step 408, method 400 proceeds to step 412, where the processor 245 using the participant tracker module 262 of the conferencing server 244 receives captured images of the participant. After receiving the captured images of the participant at step 412, method 400 proceeds to decision step 416 where processor 245 using the sync pose calculator 264 of the conferencing server 244 calculates a variance between a position of the participant and a position of the trainer and determines if a variance exists between the position of the participant and the position of the trainer. If no variance exists (NO) at decision step 416, method 400 returns to step 408. If a variance exists (YES) at decision step 416, method 400 proceeds to step 420, where the processor 245 using the sync pose advisor 266 of the conferencing server 244, prompts/advises the participant to adjust his or her movement to mimic the movement of the trainer. After the participant is prompted to adjust his or her movement to mimic the movement of the trainer, method 400 proceeds to decision step 424, where the processor 245 of the conferencing server 244 determines if the communication session has ended. If the communication session has ended (YES) at decision step 424, method 400 ends at END operation at step 428. If the communication session has not ended (NO) at decision step 424, method 400 returns to step 408.

Any of the steps, functions, and operations discussed herein can be performed continuously and automatically.

The exemplary systems and methods of this disclosure have been described in relation to communication devices, multiple-device environments, and a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein. For instance, while described in conjunction with client-server networks (e.g., conferencing servers, client devices, etc.), it should be appreciated that the components, systems, and/or methods described herein may be employed as part of a peer-to-peer network or other network. As can be appreciated, in a peer-to-peer network, the various components or systems described in conjunction with the communication system may be part of one or more endpoints, or computers, participating in the peer-to-peer network.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital communications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a communications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development locations that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

Embodiments of the present disclosure include a method. The method includes receiving, by a processor, captured image data of movement of a first participant to a communication session and receiving, by the processor, captured image data of movement of a second participant to the communication session. The method also includes determining, by the processor, if a variance exists in the movement of the second participant to that of the movement of the first participant. If a variance exists in the movement of the second participant to that of the movement of the first participant, the method further includes generating, by the processor, a prompt for the second participant to adjust the movement of the second participant to match the movement of the first participant.

Aspects of the above method include wherein the communication session is a conference call.

Aspects of the above method include wherein the prompt is an audio prompt.

Aspects of the above method include wherein the prompt is a visual prompt.

Aspects of the above method include wherein the captured image data of movement of the first participant and the captured image data of movement of the second participant are captured in real-time.

Aspects of the above method include wherein the captured image data of movement of the first participant is pre-recorded.

Aspects of the above method include wherein an artificial intelligence (AI) model is used to determine if a variance exists.

Aspects of the above method include wherein the communication session is an online training session.

Embodiments of the present disclosure include a system. The system includes a processor and a memory coupled with and readable by the processor and having stored therein a set of instructions which, when executed by the processor, causes the processor to receive captured image data of movement of a first participant to a communication session. The processor is also caused to receive captured image data of movement of a second participant to the communication session and determine if a variance exists in the movement of the second participant to that of the movement of the first participant. If a variance exists in the movement of the second participant to that of the movement of the first participant, the processor is further caused to generate a prompt for the second participant to adjust the movement of the second participant to match the movement of the first participant.

Aspects of the above system include wherein the communication session is a conference call.

Aspects of the above system include wherein the prompt is an audio prompt.

Aspects of the above system include wherein the prompt is a visual prompt.

Aspects of the above system include wherein the captured image data of movement of the first participant and the captured image data of movement of the second participant are captured in real-time.

Aspects of the above system include wherein the captured image data of movement of the first participant is pre-recorded.

Aspects of the above system include wherein an artificial intelligence (AI) model is used to determine if a variance exists.

Aspects of the above system include wherein the communication session is an online training session.

Embodiments of the present disclosure include a tangible and non-transitory computer readable medium comprising microprocessor executable instructions that, when executed by the microprocessor, perform the following functions of receiving captured image data of movement of a first participant to a communication session, receiving captured image data of movement of a second participant to the communication session and determining if a variance exists in the movement of the second participant to that of the movement of the first participant. If a variance exists in the movement of the second participant to that of the movement of the first participant, a further function is performed of generating a prompt for the second participant to adjust the movement of the second participant to match the movement of the first participant. Aspects of the above computer readable medium include wherein the communication session is an online training session.

Aspects of the above computer readable medium include wherein the prompt is an audio prompt.

Aspects of the above computer readable medium include wherein the prompt is a visual prompt.

Any one or more of the aspects or embodiments as substantially disclosed herein optionally in combination with any one or more other aspects/embodiments as substantially disclosed herein.

One or means adapted to perform any one or more of the above aspects or embodiments as substantially disclosed herein.

Methods described or claimed herein can be performed with traditional executable instruction sets that are finite and operate on a fixed set of inputs to provide one or more defined outputs. Alternatively, or additionally, methods described or claimed herein can be performed using AI, machine learning, neural networks, or the like. In other words, a system or server is contemplated to include finite instruction sets and/or artificial intelligence-based models/neural networks to perform some or all of the steps described herein.

What is claimed is:

1. A method, comprising:
receiving, by a processor, captured image data of movement of a first participant to a communication session;
receiving, by the processor, captured image data of movement of a second participant to the communication session;
determining, by the processor, if a variance exists in the movement of the second participant to that of the movement of the first participant; and
if a variance exists in the movement of the second participant to that of the movement of the first participant, generating, by the processor, a prompt for the second participant to adjust the movement of the second participant to match the movement of the first participant.

2. The method according to claim 1, wherein the communication session is a conference call.

3. The method according to claim 1, wherein the prompt is an audio prompt.

4. The method according to claim 1, wherein the prompt is a visual prompt.

5. The method according to claim 1, wherein the captured image data of movement of the first participant and the captured image data of movement of the second participant are captured in real-time.

6. The method according to claim 1, wherein the captured image data of movement of the first participant is pre-recorded.

7. The method according to claim 1, wherein an artificial intelligence (AI) model is used to determine if a variance exists.

8. The method according to claim 1, wherein the communication session is an online training session.

9. A system, comprising:
a processor; and
a memory coupled with and readable by the processor and having stored therein a set of instructions which, when executed by the processor, causes the processor to:
receive captured image data of movement of a first participant to a communication session;
receive captured image data of movement of a second participant to the communication session;
determine if a variance exists in the movement of the second participant to that of the movement of the first participant; and
if a variance exists in the movement of the second participant to that of the movement of the first participant, generate a prompt for the second participant to adjust the movement of the second participant to match the movement of the first participant.

10. The system according to claim 9, wherein the communication session is a conference call.

11. The system according to claim 9, wherein the prompt is an audio prompt.

12. The system according to claim 9, wherein the prompt is a visual prompt.

13. The system according to claim 9, wherein the captured image data of movement of the first participant and the captured image data of movement of the second participant are captured in real-time.

14. The system according to claim 9, wherein the captured image data of movement of the first participant is pre-recorded.

15. The system according to claim 9, wherein an artificial intelligence (AI) model is used to determine if a variance exists.

16. The system according to claim 9, wherein the communication session is an online training session.

17. A tangible and non-transitory computer readable medium comprising microprocessor executable instructions that, when executed by the microprocessor, perform the following functions:
receiving captured image data of movement of a first participant to a communication session;
receiving captured image data of movement of a second participant to the communication session;
determining if a variance exists in the movement of the second participant to that of the movement of the first participant; and
if a variance exists in the movement of the second participant to that of the movement of the first participant, generating a prompt for the second participant to adjust the movement of the second participant to match the movement of the first participant.

18. The computer readable medium according to claim 17, wherein the communication session is an online training session.

19. The computer readable medium according to claim 17, wherein the prompt is an audio prompt.

20. The computer readable medium according to claim 17, wherein the prompt is a visual prompt.
